(19) United States
(12) Patent Application Publication
(10) Pub. No.: US 2011/0136252 A1
(43) Pub. Date: Jun. 9, 2011

(54) Integrated Microfluidics for Parallel Screening of Chemical Reactions

(75) Inventors: Hsian-Rong Tseng, Los Angeles, CA (US); Hartmuth C. Kolb, Marina del Rey, CA (US); Jinyi Wang, Los Angeles, CA (US); Guodong Sui, Los Angeles, CA (US)

(73) Assignee: The Regents of the University of California, Oakland, CA (US)

(21) Appl. No.: 12/224,557

(22) PCT Filed: Mar. 2, 2007
(86) PCT No.: PCT/US07/05248

§ 371 Date: Feb. 24, 2010

Related U.S. Application Data
(60) Provisional application No. 60/778,430, filed on Mar. 2, 2006.

(51) Int. Cl. G01N 1/10; B01L 3/00

(52) U.S. Cl. 436/180; 422/502; 422/505

(57) ABSTRACT

A microfluidic device allows for different reactions to be conducted in parallel with the use of nanoliter quantities of reagents.

### CROSS-REFERENCE OF RELATED APPLICATION

This application claims priority to U.S. Provisional Application No. 60/778,430 filed Mar. 2, 2006, the entire contents of which are hereby incorporated by reference.

### BACKGROUND

1. Field of Invention

The current invention relates to microfluidic devices and methods, and more particularly to microfluidic devices and methods for parallel reactions.

2. Discussion of Related Art

Microfluidic devices can offer a variety of advantages over macroscopic reactors, such as reduced reagent consumption, high surface-to-volume ratios, and improved control over mass and heat transfer. (See, K. Jahnisch, V. Hessel, H. Lowe, M. Baerns, Angew. Chem. 2004, 116, 410-451; Angew. Chem. Int. Ed. Engl. 2004, 43, 406-446; P. Watts, S. J. Haswell, Chem. Soc. Rev. 2005, 34, 235-246; and G. Jas, A. Kirschning, Chem.-Eur. J. 2003, 9, 5708-5723.) Organic reactions that involve highly reactive intermediates can exhibit greater selectivities and specificities in reactions performed in microfluidic devices, e.g., microreactors, than in conventional macroscopic synthesis. (See, T. Kawaguchi, H. Miyata, K. Ataka, K. Mae, J. Yoshida, Angew. Chem. 2005, 117, 2465-2468; Angew. Chem. Int. Ed. Engl. 2005, 44, 2413-2416; and D. M. Ratner, E. R. Murphy, M. Jhunjhunwala, D. A. Snyder, K. F. Jensen, P. H. Seeberger, Chem. Commun. 2005, 578-580.) A microfluidic device can be integrated with a computer control system in order to perform complicated chemical and biological processes in an automated fashion.

However, past microfluidic devices were often limited in their ability to perform multistep syntheses. The individual steps of multistep syntheses can require the changing of solvents, reagents, and conditions.

Furthermore, past microfluidic devices often did not lend themselves to parallel syntheses. In a parallel synthesis, similar types of reactions can be performed using different combinations of reagents. For example, in biological or biochemical investigations, a researcher may need to carry out many different reactions simultaneously. For example, the fraction of the total number of reactions which yield desired product or indicate positive results may be low, so that a large number of reactions must be carried out. Such investigations include, for example, screening a large number of compounds for efficacy as a drug. Performing a large number of reactions sequentially can be prohibitively expensive, for example, in terms of researcher or technician time. Furthermore, if a long incubation or reaction time is required, too long a time may be required for the study. Performing a large number of reactions in parallel with conventional macroscopic laboratory equipment can be prohibitively expensive, for example, in terms of the apparatus required, overhead cost, or the quantities of reagents required.

Even though the small length scales inherent in microfluidic devices could have provided a number of advantages, the small length scales posed challenges for certain operations. For example, the small length scales and associated low fluid velocities inherent in the operation of past microfluidic devices resulted in a low Reynolds number for fluid flows through the devices. That is, the fluid flows were often in the laminar regime. Because turbulent flow was not achieved, mixing was often poor, and the inhomogeneity of the fluids caused poor results or complicated the interpretation of data.

Therefore, there is a need for microfluidic devices with which multistep syntheses can be performed in parallel, individual steps can be isolated, and good mixing of reagents in fluid combinations can be obtained.

### SUMMARY

Further objectives and advantages will become apparent from a consideration of the description, drawings, and examples.

A microfluidic device according to an embodiment of the current invention has a plurality of fluid sources, in selective fluid connection with a plurality of fluid input microchannels, a mixing section in fluid connection with the plurality of fluid input microchannels, and a plurality of microvessels, each being in selective fluid connection with the mixing section. The mixing section is adapted to receive a plurality of fluid combinations from the plurality of fluid input microchannels and output a corresponding plurality of mixed fluids to a respective one of the plurality of microvessels while in operation. The microfluidic device thereby provides a plurality of chemical reactions which proceed in parallel.

A method of performing a plurality of chemical reactions in parallel according to an embodiment of the current invention includes independently selecting quantities of at least two reagents, mixing the reagents to form a test mixture, selecting a microvessel, conveying the test mixture to the selected microvessel, and repeating the steps of independently selecting quantities of at least two reagents, mixing the reagents, selecting a microvessel, and conveying the test mixture until a predetermined number of microvessels has been selected.

### BRIEF DESCRIPTION OF THE DRAWINGS

FIG. 1 is a schematic illustration of a microfluidic device according an embodiment of the current invention.

FIG. 2A is a schematic representation of a microfluidic device used for the parallel screening of an in situ click chemistry library according to an embodiment of the current invention.

FIG. 2B is an optical image of an actual device according to an embodiment of the current invention.

FIGS. 3A-3D are schematic diagrams that illustrate four sequential processes for preparing an individual in situ click chemistry mixture in the microfluidic device according to an embodiment of the current invention.

FIG. 4 is a summary of in situ click chemistry screening results between acetylene 1 and azides 2-21 obtained using the microfluidic device according to an embodiment of the current invention and (in parentheses) 96-well microtiter plates.

FIG. 5 presents the results of LC/MS analysis of in situ click chemistry reactions between acetylene 1 and azide 2. a) Triazole product obtained through Cu¹-catalyzed reaction; b) microchip-based reaction performed in the presence of bCAII (bovine carbonic anhydrase H); c) microchip-based reaction performed in the presence of both bCAII and inhibitor 22, and d) microchip-based reaction performed in the absence of bCAII; e) reaction performed in a 96-well microtiter plate in the presence of bCAII.

FIG. 6 presents the results of LC/MS analysis of in situ click chemistry reactions between acetylene 1 and azide 3. a) Triazole product; b) microchip-based reaction performed in the presence of bCAII, c) microchip-based reaction performed in the presence of both bCAII and inhibitor 22, and d) microchip-based reaction performed in the absence of bCAII.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the spirit and scope of the invention. All references cited herein are incorporated by reference as if each had been individually incorporated.

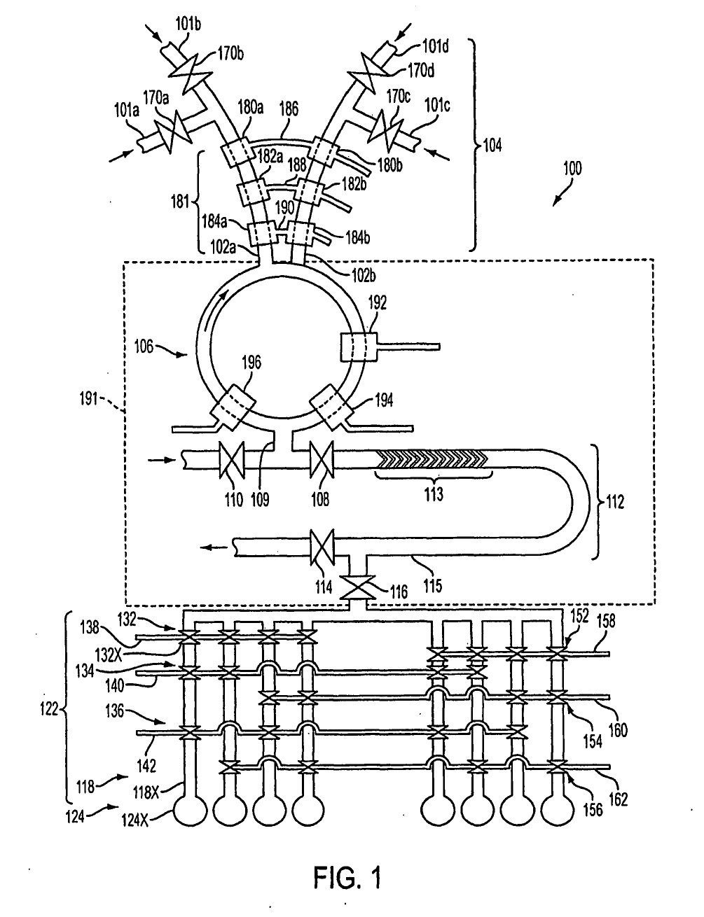

An embodiment of a microfluidic device according to the current invention is illustrated schematically in FIG. 1. The device can be implemented by a soft lithography technique. For example, a layer of polydimethylsiloxane (PDMS) can be applied to a surface. The layer can be coated with resist, exposed to a light pattern and etched to create fluid channels in a predefined pattern. Successive steps of coating, exposing, and etching can be used to create fluid channels on several superimposed levels. For example, a first level of fluid channels can be designed to guide the flow of reagents intended for synthesis of the compounds of interest. A second level of fluid channels can be designed to transmit pressure in control lines used to actuate pumps and/or valves used to transport and control the reagents flowing in the first level. The first level and the second level can be separated by a thin film of PDMS. The separating layer can act to isolate reagents in the first level from the fluid in the control lines in the second level. Furthermore, the separating layer of PDMS can act as a component of microscale devices such as pumps and valves. For example, pressure applied on a control line in the second level may act to deform the separating layer above a fluid channel in the first level, and thereby block the flow of reagent through the fluid channel; i.e., the separating layer may act as a valve.

In one embodiment, the microfluidic device 100 illustrated in FIG. 1 includes two or more fluid sources (101a, 101b, 101c, 101d). Each fluid source (101a, 101b, 101c, 101d) can contain a different chemical reagent. The microfluidic device 100 includes two or more fluid input microchannels (102a and 102b). The microfluidic device 100 is not limited to only two input microchannels (102a and 102b). For example, it can include three or more fluid input microchannels. Valves (170a, 170b, 170c, 170d) regulate the flow of fluid from a fluid source (101a, 101b, 101c, 101d) into a fluid input microchannel (102a and 102b).

In one embodiment, the fluid input microchannel (102a and 102b) includes a metering pump 181. The metering pump includes upstream pump valves (180a and 180b), midstream pump valves (182a and 182b), and downstream pump valves (184a and 184b). The upstream pump valve 180a associated with the fluid input microchannel 102a is connected to the other upstream pump valve 180b associated with the other fluid input microchannel 102b by an upstream control line 186; the midstream pump valve 182a is connected to the other midstream pump valve 182b by a midstream control line 188; and the downstream pump valve 184a is connected to the other downstream pump valve 184b by a downstream control line 190.

The microfluidic device 100 can include a mixing section 191 fluidly connected to the two or more fluid input microchannels (102a and 102b).

In one embodiment, the mixing section 191 includes a rotary mixer 106. The rotary mixer 106 is fluidly connected to the fluid input microchannels (102a and 102b). The rotary mixer 106 includes a rotary mixer pump. The rotary mixer pump in this embodiment includes at least three pump valves. The rotary mixer pump includes a first pump valve 192, a second pump valve 194, and a third pump valve 196. The rotary mixer 106 is fluidly connected to a rotary mixer output microchannel 109. The rotary mixer output microchannel 109 can include a rotary mixer output valve 108 and a purge inlet valve 110.

The rotary mixer 106 can have a volume within the range of from about 5 nL (nanoliters) to about 12500 nL, can have a volume within the range of from about 25 nL to about 2500 nL, and can have a volume of about 250 nL.

In one embodiment, the mixing section includes a chaotic mixer 112. The chaotic mixer 112 includes a fluid channel 113 having at least one protrusion, which induces chaotic advection to induce mixing of fluid traveling through the channel. The chaotic mixer 112 is fluidly connected to a chaotic mixer output microchannel 115. The chaotic mixer output microchannel 115 includes a chaotic mixer output valve 116 and a purge outlet valve 114.

In one embodiment, the rotary mixer output microchannel 109 is fluidly connected to the chaotic mixer 112.

The microfluidic device 100 can include a plurality of microvessels 124, e.g., microvessel 124x, each microvessel 124 being in selective fluid connection with the mixing section 191.

In one embodiment, the microfluidic device 100 includes a microfluidic multiplexer 122. The microfluidic multiplexer 122 is fluidly connected to the mixing section 191 and is fluidly connected to the plurality of microvessels 124. The microfluidic multiplexer 122 serves as the selective fluid connection of each microvessel 124 with the mixing section 191.

In one embodiment, the microfluidic multiplexer 122 includes two or more multiplexer microchannels 118, e.g., multiplexer microchannel 118x. Each multiplexer microchannel 118 is fluidly connected with one microvessel 124, and each multiplexer microchannel 118 comprises at least one multiplexer valve (132, 134, 136, 152, 154, 156), e.g., multiplexer valve 132x. The microfluidic multiplexer 122 comprises a plurality of multiplexer control lines (138, 140, 142, 158, 160, 162) in connection with the multiplexer valves (132, 134, 136, 152, 154, 156). The number of multiplexer microchannels 118 is greater than or equal to two plus the number of multiplexer control lines (138, 140, 142, 158, 160, 162).

In one embodiment, the number of control lines (NCL) (138, 140, 142, 158, 160, 162) in the microfluidic multiplexer 122 is even and six or more. The number of multiplexer microchannels 118 is less than or equal to 2^{NCL/2}.

In one embodiment, each multiplexer microchannel 118 includes NCL/2 multiplexer valves (132, 134, 136, 152, 154, 156), and each multiplexer valve (132, 134, 136, 152, 154, 156) is connected to a multiplexer control line (138, 140, 142, 158, 160, 162). Each control line is connected to 2^{(NCL/2-1)} multiplexer valves (132, 134, 136, 152, 154, 156), each multiplexer valve (132, 134, 136, 152, 154, 156) being on a separate multiplexer microchannel 118. The set of multiplexer control lines (138, 140, 142, 158, 160, 162) to which the multiplexer valves (132, 134, 136, 152, 154, 156) on a multiplexer microchannel 118 are connected are not the same as the set of multiplexer control lines (138, 140, 142, 158, 160, 162) to which the multiplexer valves (132, 134, 136, 152, 154, 156) on any other microchannel 118 are connected.

The multiplexer control lines (138, 140, 142, 158, 160, 162) of the microfluidic multiplexer 122 can contain a fluid having a pressure. By applying a pressure to the fluid, the state of the multiplexer valves (132, 134, 136, 152, 154, 156) to which the multiplexer control line (138, 140, 142, 158, 160, 162) is connected can be changed. For example, by applying pressure, the state of the multiplexer valves (132, 134, 136, 152, 154, 156) can be changed from open to closed, so that fluid cannot pass through the microchannel 118. As another example, by releasing pressure, the state of the multiplexer valves (132, 134, 136, 152, 154, 156) can be changed from closed to open, so that fluid can pass through the microchannel 118. The multiplexer control lines (138, 140, 142, 158, 160, 162) of the microfluidic multiplexer 122 can contain a liquid as the fluid, and the control lines can be termed hydraulic control lines. The control lines of the microfluidic multiplexer can contain a gas as the fluid, and the control lines can be termed pneumatic control lines.

One embodiment of a method according to the invention includes the following. The user (or a control device, e.g., a computer) can independently select quantities of two or more reagents. The user can independently select quantities of three or more reagents. The mixing section of the microfluidic device 100 mixes the selected reagents to form a test mixture. The user (or a control unit, such as a computer) then selects a microvessel 124 to which the test mixture is to be transferred. The microfluidic device 100 conveys the test mixture to the selected microvessel 124. The steps of independently selecting quantities of at least two reagents, mixing the reagents, selecting a microvessel 124, and conveying the test mixture can be repeated until a predetermined number of microvessels 124 has been selected.

The test mixture can have a volume of from about 0.1 μL to about 80 μL, can have a volume of from about 1 μL to about 16 μL, and can have a volume of about 4 μL.

The user can allow test mixtures in each selected microvessel 124 to react for a predetermined period of time. The user can extract a test mixture from a selected microvessel 124, and can analyze the extracted test mixture.

In one embodiment, conveying the test mixture to the selected microvessel 124 includes the following. The user (or a control unit, such as a computer) identifies the microchannel 118 in fluid connection with the selected microvessel. The user identifies the multiplexer valves (132, 134, 136, 152, 154, 156) associated with the identified microchannel. The user identifies the multiplexer control lines (138, 140, 142, 158, 160, 162) associated with the identified multiplexer valves. The user then sets the state of the identified multiplexer control lines, e.g., the user can deactuate the identified multiplexer control lines to cause all identified multiplexer valves to open. Deactuating the identified multiplexer control lines can include relieving pressure applied to a fluid in the identified multiplexer control lines. The user can then set the state of the other, non-identified multiplexer control lines, e.g., the user can actuate the other, non-identified multiplexer control lines, in order to cause all non-identified multiplexer valves to close. Actuating the non-identified multiplexer control lines can include applying or maintaining pressure on a fluid in the non-identified multiplexer control lines.

In one embodiment, the user (or a control unit, such as a computer), by deactuating identified multiplexer control lines and actuating non-identified multiplexer control lines, causes no non-identified microchannel to have all of the multiplexer valves associated with the non-identified microchannel being open.

In one embodiment, conveying the test mixture to the selected microvessel 124 can include applying pressure to the text mixture. Conveying the test mixture to the selected microvessel 124 can include applying pressure to a fluid in contact with the test mixture.

In one embodiment, mixing the input reagents to form a test mixture can include opening and closing valves in a rotary mixer 106 in a predetermined order to drive the input reagents in a clockwise or in a counterclockwise direction by peristaltic action. For example, the user (or a control unit, such as a computer) can (a) close a first valve 192 and open a second valve 194 and a third valve 196 of a rotary mixer 106, (b) close the second valve 194 of the rotary mixer 106 to force fluid away from the first valve 192, and (c) close the third valve 196 and open the first valve 192 and second valve 194 of the rotary mixer 106. The user (or a control unit, such as a computer) can repeat steps (a), (b), and (c) as long as desired, for example, until the test mixture has a predetermined length scale of homogeneity.

A predetermined length scale of homogeneity arises from considering two cubes of fluid. The length of edges of the cubes for which the average concentration of each reagent in a cube varies from the average concentration of the reagent in the other cube by no more than a predetermined percentage, e.g., 10%, regardless of the location of each cube in the volume of fluid, and for which a decrease in the length of the edges would result in an increase in variation of the average concentration over this predetermined percentage, is the length scale of homogeneity in the fluid.

The test mixture can be conveyed through the chaotic mixer 112 and to the microfluidic multiplexer 122 by opening the purge inlet valve 110 and applying pressure to drive a bulk fluid through the purge inlet valve 110 toward the chaotic mixer 112. The bulk fluid can exert a pressure on the test mixture to drive the test mixture through the chaotic mixer. The bulk fluid can exert a pressure on the test mixture to drive the test mixture to and through the microfluidic multiplexer 122.

Although the embodiments described above have hydraulic and/or pneumatic valves, broad concepts of the invention are not limited to only such structures. Furthermore, microfluidic devices according to the current invention are not limited to only PDMS structures as described in the above embodiments.

A microfluidic device such as in the embodiments described above can be integrated with analytical instruments. For example, a reaction product from a microfluidic device can be directed to an analytical instrument such as LC/MS (liquid chromatography/mass spectrometry) instruments. (See, W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engi. 2002, 41, 1053-1057; V. D. Bock, H. Hiemstra, J. H. van Maarseveen, Eur. J. Org. Chem. 2005, 51-68; and V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engi. 2005, 44, 116-120.) Integrated microfluidics can provide an excellent experimental platform, for example, for the screening of chemical compounds, such as in the identification of pharmaceutically active compounds, because it enables parallelization and automation. The minaturization associated with integrated microfluidics allows economical use of reagents, such as target proteins and expensive chemical compounds.

### EXAMPLES

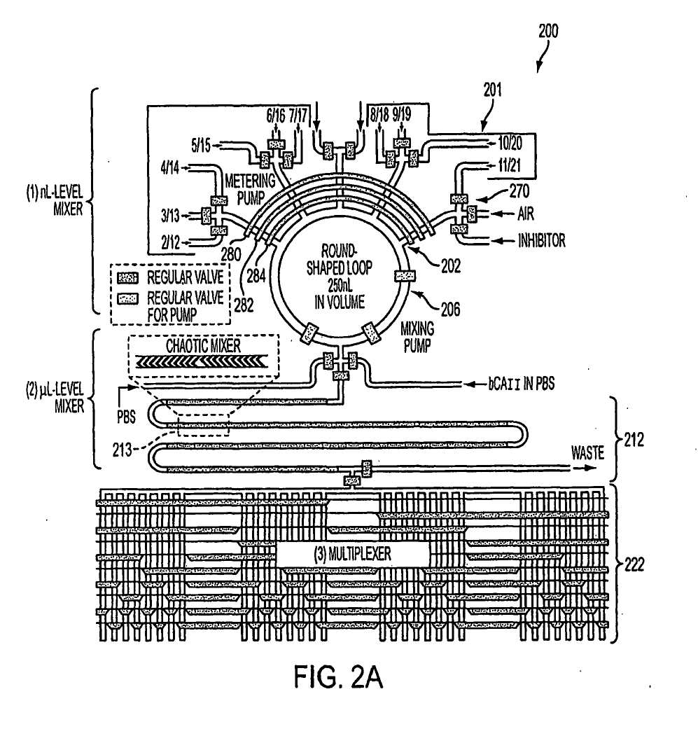

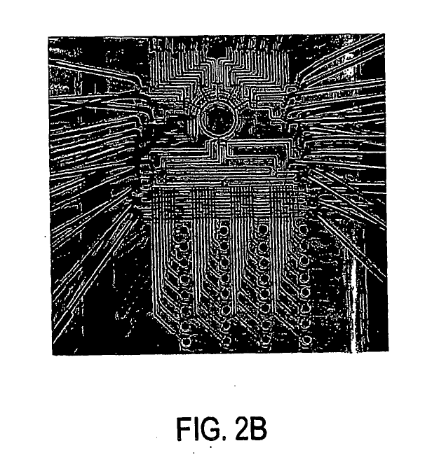

A schematic of a microfluidic device according to the invention that was constructed is presented in FIG. 2A. A photograph of this microfluidic device is presented in FIG. 2B. With this microfluidic device, 32 different mixtures of reagents can be allowed to react simultaneously, i.e., in parallel.

The microfluidic device in this example can produce test mixtures having a volume of about 4 μL. For example, in situ click chemical reactions can be investigated with such test mixtures. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) For example, a 4 μL volume test mixture can include 19 μL of an enzyme, 2.4 nmol of an acetylene compound, and 3.6 nmol of an azide compound.

In contrast, in a conventional approach, test mixtures of in situ click chemistry reactants have a volume of 100 μL, and contain 94 μg of enzyme, 6 nmol of an acetylene and 40 nmol of an azide. This illustrates that a microfluidic device according to the present invention requires smaller quantities of reagents than a conventional approach. The conservation of reagents by the microfluidic device is of advantage, for example, when the reagents are expensive to buy or difficult to produce.

The microfluidic device 200 according to an embodiment of the current invention (FIGS. 2A and 2B) comprises the following. A nanoliter (nL)-level rotary mixer 206 with a total volume of about 250 nL is shown in FIG. 2A. This round-shaped loop, along with associated fluid input microchannels 202, pump valves (280, 282, 284), valves 270 and fluid sources 201, can selectively sample, precisely meter, and mix nanoliter quantities of reagents. (See, M. A. Unger, H. P. Chou, T. Thorsen, A. Scherer, S. R. Quake, Science 2000, 288, 113-116.) For example, in the in situ click chemistry experiment performed, 80 nL of an acetylene compound (acetylene 1), 120 nL of an azide compound (azides 1-11 or 12-21), and up to 40 nL of an inhibitor (inhibitor 22) were mixed for each test mixture.

A microliter (μL)-level chaotic mixer 212 for combining the nanoliter quantity of mixed reagents from the rotary mixer 206 with μL-amounts of a bCAII (bovine carbonic anhydrase II) solution in phosphate buffer saline (PBS, pH 7.4) is shown in FIG. 2A. (See, A. D. Stroock, S. K. W. Dertinger, A. Ajdari, I. Mezic, H. A. Stone, G. M. Whitesides, Science 2002, 295, 647-651.) A homogenous reaction mixture was generated via chaotic mixing inside a 37.8-mm long microchannel 213 containing embedded micropatterns, that is, containing protrusions, which induced chaotic advection to facilitate mixing within the relatively short microchannel. (See, A. D. Stroock, S. K. W. Dertinger, A. Ajdari, I. Mezic, H. A. Stone, G. M. Whitesides, Science 2002, 295, 647-651.) The micropatterns were 20% longer than theoretically required to ensure efficient mixing. (31.5 mm long micropatterns are required to achieve efficient mixing in 200 μm wide microchannels. This length was obtained according to the theoretical model described in A. D. Stroock, S. K. W. Dertinger, A. Ajdari, I. Mezic, H. A. Stone, G. M. Whitesides, Science 2002, 295, 647-651.)

A microfluidic multiplexer 222 served to guide each test mixture into one of 32 individually addressable microvessels for storing the test mixtures. (See, T. Thorsen, S. J. Maerkl, S. R. Quake, Science 2002, 298, 580-584.) The microvessels had the form of cylindrical wells, which were 1.3 mm in diameter and 6 mm in depth (and, thus, about 8 μL in volume).

A computer-controlled interface was used to program multiple steps of an operation cycle to prepare each test mixture. Thirty-two such operation cycles were compiled in sequence to create an entire library of 32 test mixtures (one for each microvessel) within the microfluidic device in a run.

### Operation Cycle

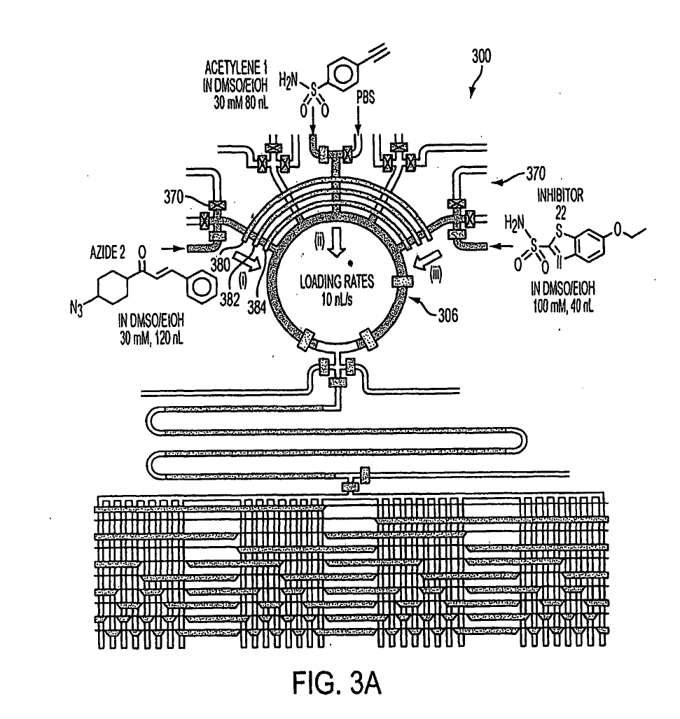

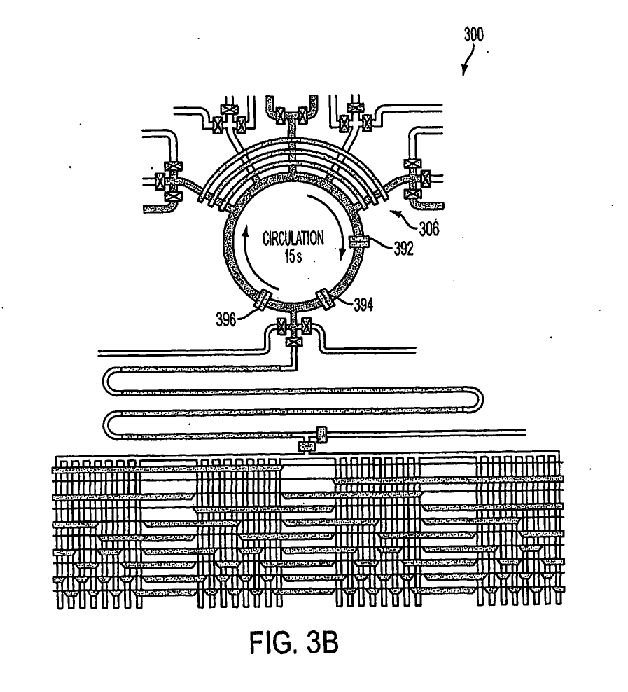

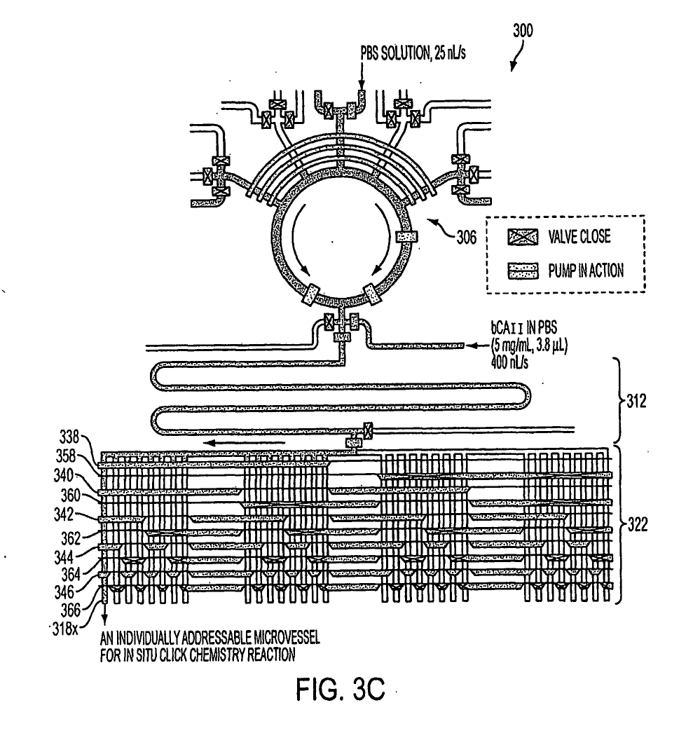

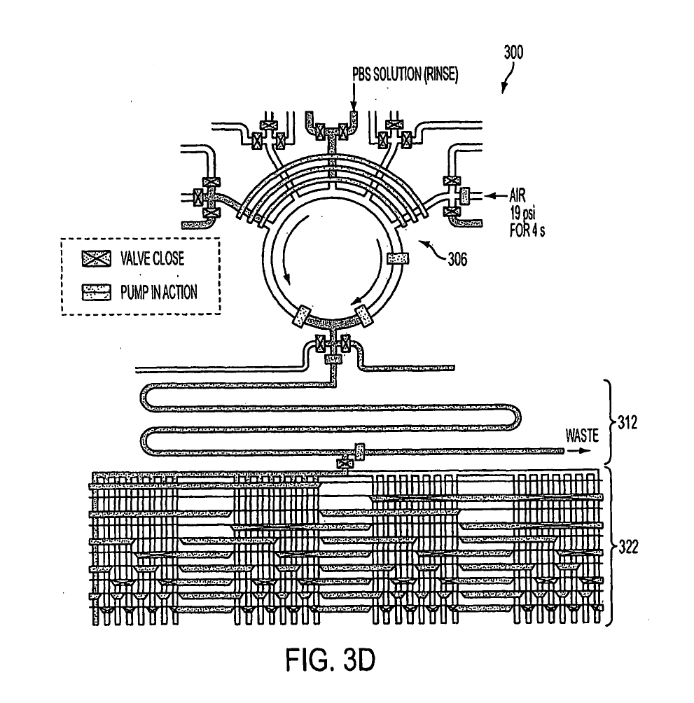

The method of producing each test mixture in a microfluidic device 300 is illustrated in FIGS. 3A-3D. FIG. 3A shows that metering pumps 380, 382, 384 were used to introduce an azide 2, an acetylene 1, and an inhibitor 22 into the rotary mixer 306 sequentially, at a flow rate of about 10 nL/sec. The appropriate configuration of the valves 370 is shown (closed valves are designated with an X). PBS solution was then introduced by the metering pumps 380, 382, 384 to fill the round-shaped loop of the rotary mixer 306 completely.

FIG. 3B shows that the reagent solutions were then mixed for 15 seconds in the nL-scale rotary mixer 306 (circulation rate: ca 18 cycle/min) by using the mixing pump. The mixing pump was formed of valves 392, 394, 396 which were cycled open and closed as described above to cause a peristaltic pumping action of the reagent solutions around the loop of the rotary mixer 306.

FIG. 3C shows that the reagent solutions in the rotary mixer 306 were then forced out of the rotary mixer 306 and into the chaotic mixer 312 by introducing a PBS solution into the rotary mixer 306 at a flow rate of about 25 nL/sec. At the same time, a total of 3.8 μL of bCAII solution was introduced at a flow rate of about 400 nL/sec into the chaotic mixer 312. The test mixture was thus induced to flow through the chaotic mixer 312 and into the microfluidic multiplexer 322. The multiplexer control lines 338, 340, 342, 344, and 346 were deactuated so that all multiplexer valves associated with the microchannel 318x were open and the test mixture could flow through microchannel 318x into the microvessel fluidly connected to the end of the microchannel 318x (not shown). All of the other multiplexer control lines 358, 360, 362, 364, and 366 were actuated to close multiplexer valves so that no other microchannel had all its associated multiplexer valves open, and the test mixture could not flow into any other microvessel.

FIG. 3D shows that the channels of the rotary mixer 306, the chaotic mixer 312 and the microfluidic multiplexer 322 through which the test mixture had passed in the steps illustrated by FIGS. 3A-3C and discussed above were then rinsed by introducing 2 μL of a PBS solution and introducing an air flow purge. This prevented cross-contamination between an operation cycle and the subsequent operation cycle.

The operation cycle illustrated in FIGS. 3A-3D and discussed above was repeated, but with subsequently different settings of the multiplexer control lines 338, 340, 342, 344, 346, 358, 360, 362, 364, and 366, in order to select different microvessels, a total of 32 times. Completion of the 32 operation cycles to fill each of the microvessels with a different test mixture took approximately 30 minutes (about 57 sec/cycle). After each of the 32 microvessels were filled, the microfluidic device 300 was placed into a moisture-regulated incubator at 37° C. for 40 h to complete the reactions of the test mixtures in the microvessels. Thus, 32 different reactions proceeded simultaneously over a time interval much shorter than if the 32 reactions had been carried out sequentially, one after the other.

After incubation, the reacted test mixtures were collected from the microvessels. Each microvessel was rinsed with MeOH (5 μL×3), and the rinsing solution for a microvessel was combined with the original reacted test mixture in the microvessel. LC/MS analysis was performed on each of the test mixtures.

### Chemistry

The in situ click chemistry investigated with the microfluidic device according to the current invention is a target-guided synthesis method for discovering high-affinity protein ligands by assembling complementary azide and acetylene building blocks inside the target's binding pockets through 1,3-dipolar cycloaddition. (See, D. Rideout, Science 1986, 233, 561-563; I. Huc, J. M. Lehn, Proc. Natl. Acad. Sci. U.S.A. 1997, 94, 2106-2110; J. M. Lehn, A. V. Eliseev, Science 2001, 291, 2331-2332; O. Ramstrom, J. M. Lehn, Nat. Rev. Drug Discovery 2002, 1, 26-36; D. A. Erlanson, A. C. Braisted, D. R. Raphael, M. Randal, R. M. Stroud, E. M. Gordon, J. A. Wells, Proc. Natl. Acad. Sci. U.S.A. 2000, 97, 9367-9372; K. C. Nicolaou, R. Hughes, S. Y. Cho, N. Winssinger, C. Smethurst, H. Labischinski, R. Endermann, Angew. Chem. 2000, 112, 3981-3986; Angew. Chem. Int. Ed. Engl. 2000, 39, 3823-3828; W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engl. 2002, 41, 1053-1057; V. D. Bock, H. Hiemstra, J. H. van Maarseveen, Eur. J. Org. Chem. 2005, 51-68; V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120; and A. Krasinski, Z. Radic, R. Manetsch, J. Raushel, P. Taylor, K. B. Sharpless, H. C. Kolb, J. Am. Chem. Soc. 2005, 127, 6686-6692.)

The resulting ligands display much higher binding affinities to the target than the individual fragments, and the hit identification is as simple as detecting product formation using analytical instruments, such as LC/MS. (See W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engl. 2002, 41, 1053-1057; and V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) The bCAII click chemistry system was used in the experiments. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) Acetylenic benzenesulfonamide (1) (K_{d}=37±6 nM) was used as the reactive scaffold (“anchor molecule”) for screening a library of 20 complementary azides 2-21. In control experiments, the active site inhibitor, ethoxazolamide (22) (K_{d}=0.15±0.03 nM), was utilized to suppress the in situ click chemistry reactions.

In order to determine appropriate reaction conditions for this microfluidics-based in situ click chemistry screening, click reactions between acetylene 1 and azide 2 were performed under different reaction conditions to ensure minimum use of enzyme and reagents and yet generate reliable and reproducible LC/MS signals for hit identification. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) The microfluidic screening platform described in this paper, utilizes a reaction volume of about 4 μL, corresponding to 19 μg of enzyme, 2.4 nmol of the acetylene, and 3.6 nmol of the azide for each reaction, instead of the 100-μL reaction mixture (containing 94 μg of the enzyme, 6 nmol of the acetylene and 40 nmol of the azide) employed in the conventional approach. Overall, a 2- to 12-fold sample economy was achieved.

In situ click chemistry screening of 10 different binary azide/acetylene combinations was performed in parallel by preparing 32 individual reaction mixtures of the following types: (i) 10 in situ click chemistry reactions between acetylene 1 and 10 azides in the presence of bCAII; (ii) 10 control reactions that are performed as in (i), but in the presence of inhibitor 22, to confirm the active-site specificity of the in situ click chemistry reactions; (iii) 10 thermal click chemistry reactions performed as in (i), but in the absence of bCAII, to monitor the enzyme-independent reactions; and (iv) a blank PBS solution containing only bCAII and a PBS solution utilized for the channel washing. Under these conditions, the entire library of twenty azides 2-21 was screened in two batches, first azides 2-13, then 12-21. A DMSO/EtOH mixture (V_{DMSO}/V_{EtOH}=1:4) was utilized as solvent for all reagents, since it does not damage the PDMS-based microchannels or affect the performance of the embedded valves and pumps. (See, J. N. Lee, C. Park, G. M. Whitesides, Anal. Chem. 2003, 75, 6544-6554.) Each in situ click chemistry reaction employed an 80 nL solution of acetylene 1 (30 mM, 2.4 nmol), a 120 nL solution of one of the azides 2-21 (30 mM, 3.6 nmol), and a 3.8 μL PBS solution of bCAII (5 mg/mL, 19 μg). For the control reactions, an additional 40 nL solution of inhibitor 22 (100 mM, 4 nmol) was added. In the thermal reactions, the bCAII solutions were replaced with blank PBS.

### Results

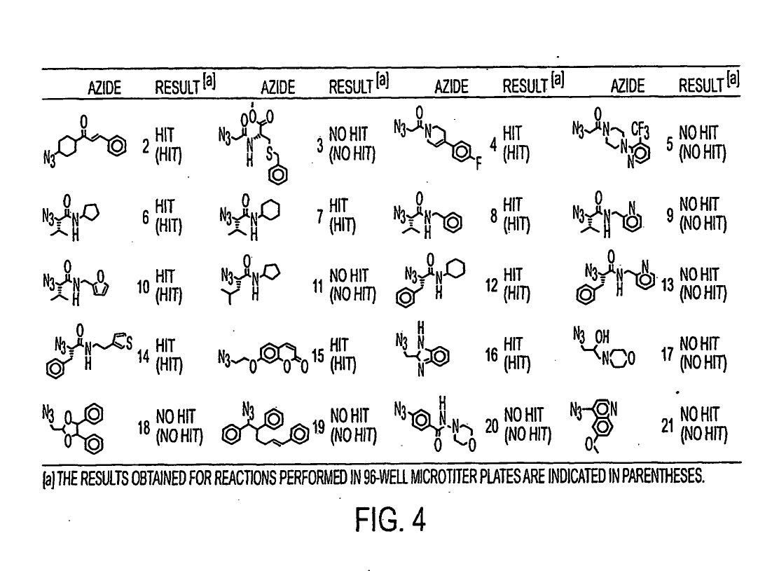

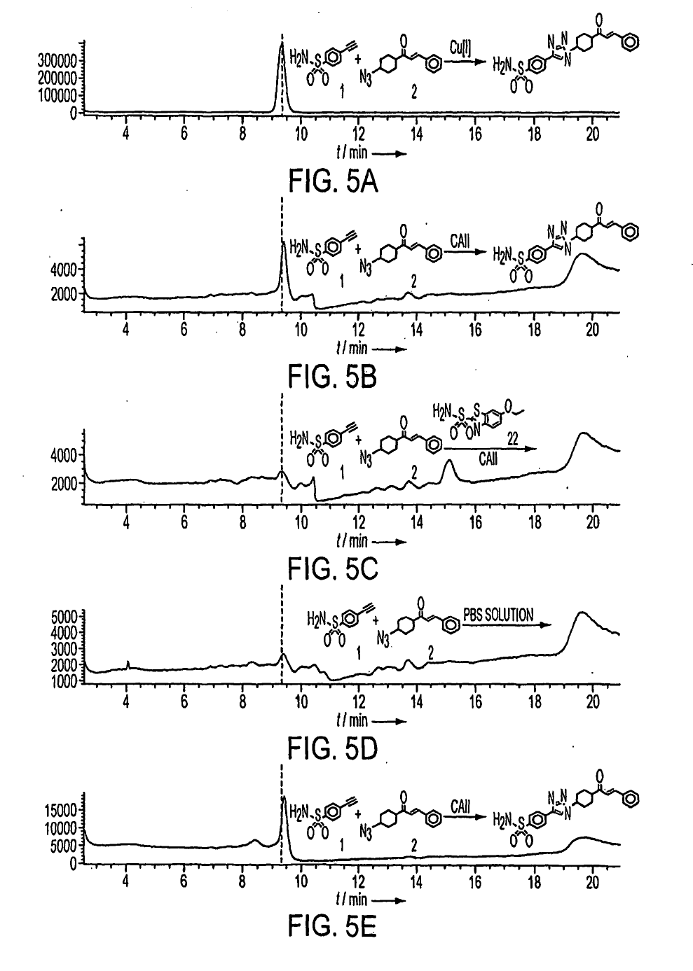

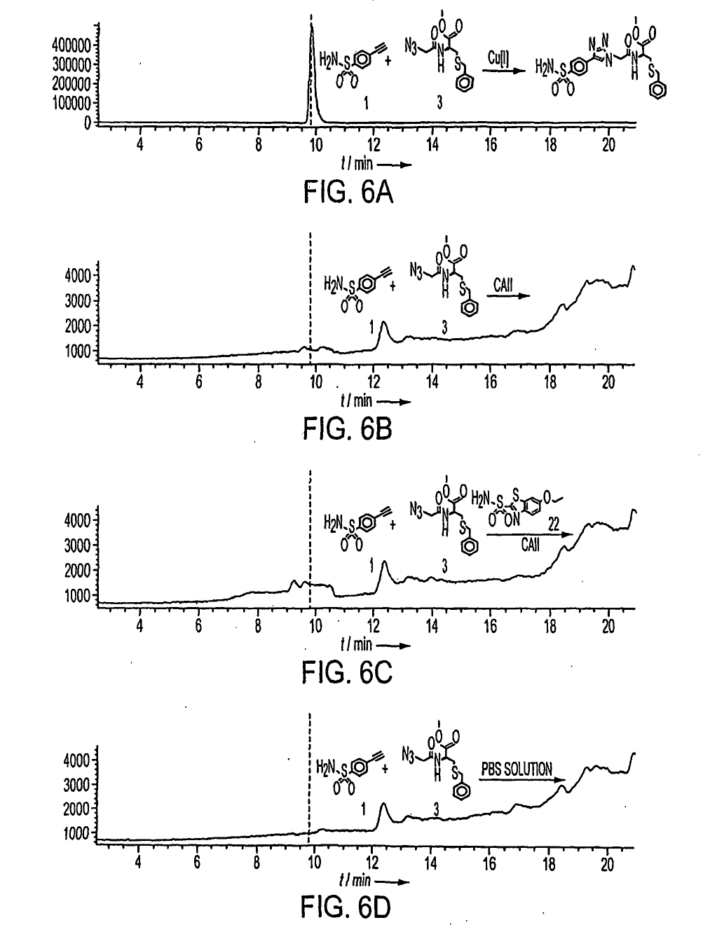

For reference purposes, the 1,4-disubstituted (“anti”) triazoles were prepared separately from the corresponding Cu¹-catalyzed reactions. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) The LC/MS analyses indicated that 10 out of the 20 reaction combinations had led to the formation of triazole products in the presence of bCAII. For comparison, all 20 in situ click chemistry reactions were also performed in 96-well microtiter plates. FIG. 4 summarizes the results of the in situ click chemistry screening between acetylene 1 and twenty azides (2-21) in the new microfluidics format and the conventional system, revealing a very similar outcome (the results obtained for reactions performed in 96-well microtiter plates are indicated in parentheses). (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) FIG. 5 illustrates the LC/MS analyses of a positive hit identification obtained for the screening reaction between acetylene 1 and azide 2 and its control studies, and FIG. 6 shows those obtained for a negative hit identification between acetylene 1 and azide 3.

All references cited herein are incorporated by reference as if each had been individually incorporated. The embodiments illustrated and discussed in this specification are intended only to teach those skilled in the art the best way known to the inventors to make and use the invention. Figures are not drawn to scale. In describing embodiments of the invention, specific terminology is employed for the sake of clarity. However, the invention is not intended 30. to be limited to the specific terminology so selected. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood .that, within the scope of the claims and their equivalents, the invention may be practiced otherwise than as specifically described.)

We claim:

1. A microfluidic device, comprising:
a plurality of fluid sources, in selective fluid connection with a plurality of fluid input microchannels;
a mixing section in fluid connection with the plurality of fluid input microchannels;
a plurality of microvessels, each being in selective fluid connection with the mixing section;
wherein the mixing section is adapted to receive a plurality of fluid combinations from the plurality of fluid input microchannels and output a corresponding plurality of mixed fluids to a respective one of the plurality of microvessels while in operation, the microfluidic device thereby providing a plurality of chemical reactions which proceed in parallel.

2. The microfluidic device of claim 1, wherein each fluid input microchannel comprises a metering pump.

3. The microfluidic device of claim 2, wherein each metering pump comprises an upstream, a midstream, and a downstream pump valve.

4. The microfluidic device of claim 1, wherein the plurality of fluid input microchannels comprises at least three fluid input microchannels.

5. The microfluidic device of claim 1, wherein the mixing section comprises a rotary mixer.

6. The microfluidic device of claim 5, wherein the rotary mixer comprises a rotary mixer pump.

7. The microfluidic device of claim 6, wherein the rotary mixer pump comprises at least 3 pump valves.

8. The microfluidic device of claim 5, wherein the rotary mixer has a volume within the range of from about 5 nL to about 12500 nL.

9. The microfluidic device of claim 5, wherein the rotary mixer has a volume within the range of from about 25 nL to about 2500nL.

10. The microfluidic device of claim 5, wherein the rotary mixer has a volume of about 250 nL.

11. The microfluidic device of claim 1, wherein the mixing section comprises a chaotic mixer.

12. The microfluidic device of claim 11, wherein the chaotic mixer comprises a fluid channel having a protrusion.

13. The microfluidic device of claim 1, further comprising a microfluidic multiplexer in fluid connection with the mixing section and in fluid connection with the plurality of microvessels,
wherein the microfluidic multiplexer provides the selective fluid connection of each microvessel with the mixing section.

14. A method of performing a plurality of chemical reactions in parallel, comprising:
independently selecting quantities of at least two reagents;
mixing the reagents to form a test mixture;
selecting a microvessel;
conveying the test mixture to the selected microvessel; and
repeating the steps of independently selecting quantities of at least two reagents, mixing the reagents, selecting a microvessel, and conveying the test mixture until a predetermined number of microvessels has been selected.

15. The method of claim 14, wherein the test mixture has a volume of from about 0.1 μL to about 80 μL.

16. The microfluidic device of claim 14,
wherein the test mixture has a volume of from about 1 μL to about 16 μL.

17. The microfluidic device of claim 14,
wherein the test mixture has a volume of about 4 μL.

18. The method of claim 14, further comprising allowing each test mixture in each selected microvessel to react for a predetermined period of time.

19. The method of claim 14, further comprising extracting a test mixture from a selected microvessel.

20. The method of claim 19, further comprising analyzing the extracted test mixture.

21. The method of claim 14, comprising independently selecting quantities of at least three reagents.

22. The method of claim 14,
wherein mixing the reagents to form a test mixture comprises opening and closing valves in a rotary mixer in a predetermined order to drive the input reagents in a clockwise or in a counterclockwise direction by peristaltic action.

23. The method of claim 14, wherein mixing reagents to form a test mixture comprises conveying the reagents through a chaotic mixer.
